(19) United States
(12) Patent Application Publication
(10) Pub. No.: US 2006/0294074 A1
(43) Pub. Date: Dec. 28, 2006

(54) Internet-based search method of contents by means of relevant lexicons

(75) Inventor: Chuan-Ying Chang, Taipei City (TW)

Correspondence Address: BACON & THOMAS, PLLC, 625 SLATERS LANE, FOURTH FLOOR, ALEXANDRIA, VA, 22314, US

(73) Assignee: CALIBER MULTIMEDIA TECHNOLOGY & TRADING CO., LTD., TAIPEI CITY (TW)

(21) Appl. No.: 11/249,482

(22) Filed: Oct. 14, 2005

(30) Foreign Application Priority Data
Jun. 27, 2005 (TW) 94121487

(51) Int. Cl. G06F 17/30

(52) U.S. Cl. 707/3

(57) ABSTRACT

An Internet-based search method of contents by means of relevant lexicons, which enables any search of the contents relevant to inputted words between a client and a server through Internet. While a search action is executed, the user can input any desired word into the client through the input device and then the client will compare whether the inputted word is the same as one of index keywords of a client index file or not. If they are the same, the matched index keyword will be transmitted to the server. After receiving an index keyword from the client, the server immediately locates one corresponding index address and transmits the corresponding index address and small icons to the client for the user's click. The client displays a content file linked to one of the index addresses.

### BACKGROUND OF THE INVENTION

1. Field of the Invention

The present invention relates generally to Internet-based search technology, and more particularly, to an Internet-based search method of contents by means of relevant lexicons, which allows users to source their desired content quickly and easily.

2. Description of the Related Art

As Internet has been being globally and universally developed, people can operate computers to go on the Internet to do interactions and learning with a variety of persons, incidents, and objects. People can also employ the Internet to search relevant information or to interact for daily life, learning, career, business, entertainment, etc. As the information on the Internet is being increased in geometric series, while facing billions of the information or web pages, general search methods focus on the predetermined full-text columns for the user to input index keywords for search, or to employ logic operations between the columns for search results, or to employ search engines of portal web sites for search of information.

There are three known search methods for information as recited below.

(1) Search based on file names: Because such search method enables the user to do the search directly by file names, the user must know specific file names that must be meaningful words. However, there are a large number of files keeping increasing and the words are limited in number. Thus, it is very difficult to manage the information by the file names, resulting in ineffective search.

(2) Search based on classifications: Multimedia files are congenitally multiple-attribute. A photo though looks like simple but can be differently classified according to different aspects and dimensions to much hardly fall into a specific classification, thus also incurring ineffective search.

(3) Search based on contents: Because there are a large number of disordered contents on the Internet, while comparisons of the multimedia files are operated, the required time is far more than what the computer system can bear. Further, there are different sizes, file formats, and compressional manners in the same kinds of the files, and more and more information of variety is increasing as time goes, thus incurring infeasibility of such method for the contents.

In addition, while the user intends to search a large number of terminologies of specific technical fields, such as zoology, botany, antiquity, eponym, toponymy, mineralogy, architecture, mechanics, hardware, chemistry, medicine, etc., even the most well-learned person in the world fails to know and identify the meaning, appearance, and detailed information of each technical term. There has been still none of any methods so far that enables the user to immediately and effectively search web pages, technical terms, serial numbers of parts, or objects in any files to retrieve the corresponding multimedia contents (images, text, sounds, animations, films videos, uniform remote locator (URL) address, etc.) with regard to the technical terms, serial numbers of the parts, or the objects.

### SUMMARY OF THE INVENTION

The primary objective of the present invention is to provide an Internet-based search method of contents by means of relevant lexicons, which enables searches of corresponding contents between clients and servers through Internet.

The foregoing objective of the present invention is attained by the method, which enables searches of the contents by means of the relevant lexicons between a client and a server through Internet. The client includes a media playback program, a client index file, and an input device. The media playback program has a display zone and an icon zone for displaying predetermined contents and a plurality of small icons respectively. The client index file has a plurality of index keywords. The input device is provided for input of words desired for search. While a search action is executed, the user can input any desired word into the client through the input device and then the client will compare whether the inputted word is the same as one of the index keywords of the client index file or not. If they are the same, the matched index keyword will be transmitted to the server. The server includes a server index file, which has a plurality of index keywords and at least one index address corresponding to each of the index keywords. The server index file further has a small icon corresponding to each of the at least one index address. The index address is linked to a predetermined content file. After receiving an index keyword from the client, the server immediately locates one corresponding index address and transmits the corresponding index address and small icons to the media playback program to display the small icons in the icon zone. Each of the small icons corresponds to each index address for hyperlink to one of the predetermined content files. In the meantime, the client displays the predetermined content file through the display zone of the media playback program. In operation, the user can click on the small icons to be linked to the predetermined content files to enable the content files to be shown on the display zone or in a new window opened thereby.

### BRIEF DESCRIPTION OF THE DRAWINGS

FIG. 1 is a schematic diagram of the framework of a first preferred embodiment of the present invention.

FIG. 2 is a partial schematic view of the framework of the first preferred embodiment of the present invention, showing the detailed framework of the client.

FIG. 3 is a partial schematic view of the framework of the first preferred embodiment of the present invention, showing the detailed framework of the server.

FIG. 4 is a schematic view of the first preferred embodiment of the first present invention in operation.

FIG. 5 is a schematic view of an operating interface of the client in accordance with the first embodiment of the present invention in operation.

FIG. 6 is a flow diagram of the operation of the first embodiment of the present invention.

FIG. 7 is a schematic diagram of the framework of a second preferred embodiment of the present invention.

### DETAILED DESCRIPTION OF PREFERRED EMBODIMENTS

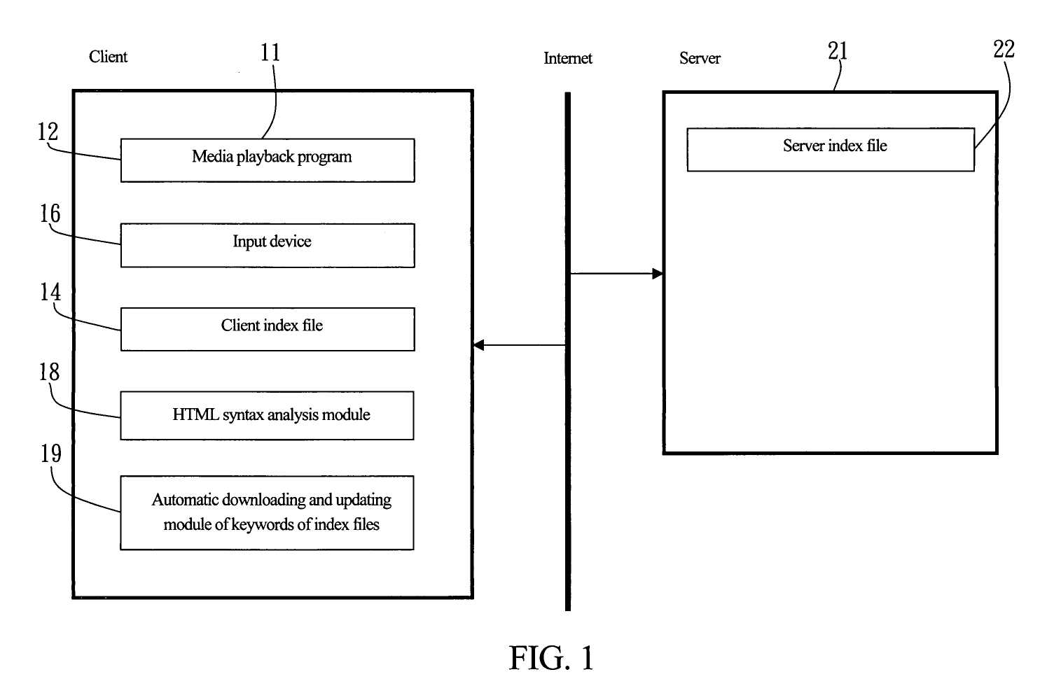

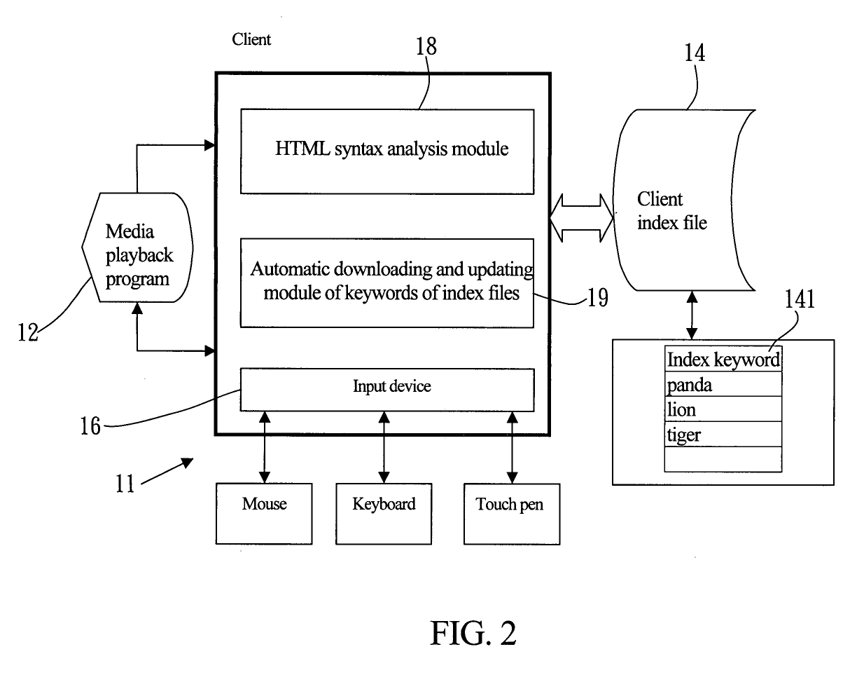

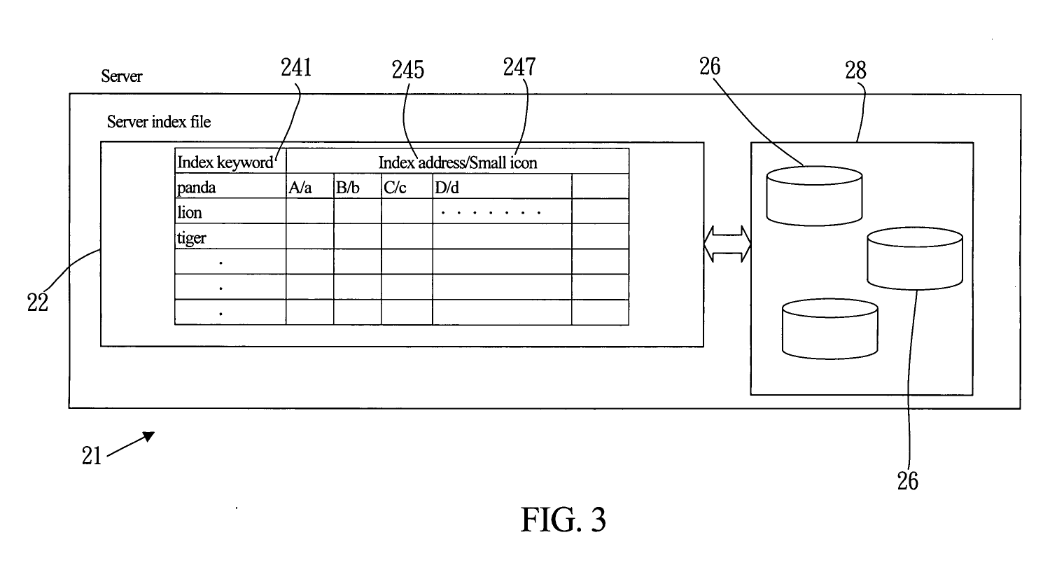

Referring to FIGS. 1-3, an Internet-based search method of contents by means of relevant lexicons, in accordance with a first preferred embodiment of the present invention, enables any search of contents by means of relevant lexicons between a client 11 and a server 21 through Internet.

The client 11 can be a personal computer (PC), a notebook computer, a cellular phone, or a personal digital assistant (PDA), including a media playback program 12, a client index file 14, an input device 16, at least one hypertext markup language (HTML) syntax analysis module 18, and an automatic downloading and updating module of keywords of index files 19.

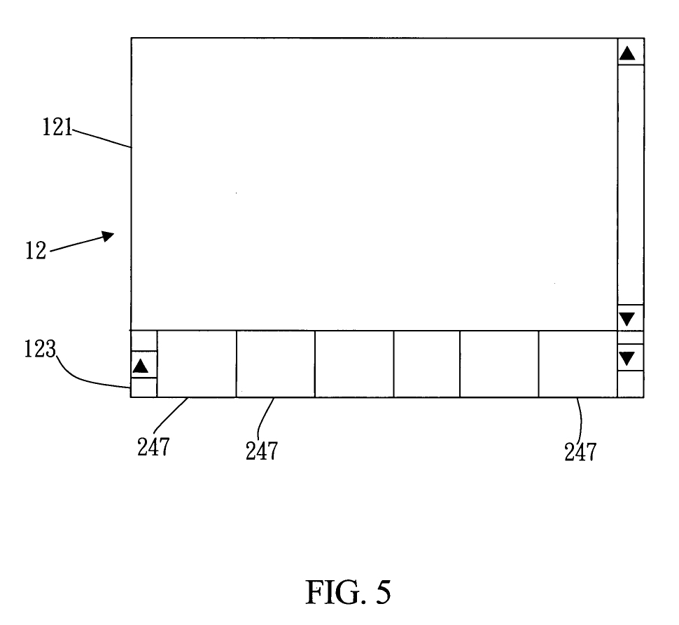

The media playback program 12 has a display zone 121 and an icon zone 123 for displaying predetermined contents and showing a plurality of predetermined small icons 247 respectively. The icon zone 123 is located beneath the display zone 121, as shown in FIG. 5.

The client index file 14 has a plurality of index keywords 141.

The input device 16 can be a mouse, a keyboard, or a touch pen to enable the user to input predetermined words by the selecting, clicking, or inputting manner.

The HTML syntax analysis module 18 is provided for recognition of HTML formatted information contained in predetermined contents while client 11 receives datastream of the predetermined contents. The datastream of the predetermined contents can be either transmitted from the server 21 or provided by opening a web page or a file on the client 11. Next, the predetermined contents are compared with the index keywords of the client index file 14 to locate all of the index keywords 141 in the datastream and to tag hypertext transfer protocol (HTTP) control information to the index keywords 141, thus enabling the index keywords 141 with the HTTP control information for the user's click. Besides, the words in the contents, as the same as the index keywords 141, are marked with predetermined colors or distinctive markers for direct click of the input device 16.

The automatic downloading and updating module of keywords of index files 19 is provided for automatically updating the index keywords 141 to be the same as those of the server 21, while the client 11 and the server 21 are connected together, to keep synchronizing the data of the client 11 and the server 21 at any time.

The server 21 can be a computer server, including a server index file 22. The server index file 22 has a plurality of index keywords 241, at least one index address 245 corresponding to each of the index keywords 241, and an icon 247 corresponding to each of the index addresses 245. While synchronized with the automatic downloading and updating module of keywords of index files 19 through the client 11, the index keywords 241 of the server index file 22 can be a comparative basis for update. The index addresses 245 can be linked either to predetermined content files 26, which are previously stored in the server 21 and can be any words, videos, audios, images, graphs, animations, file names, database contents, web pages, hyperlinks, URL addresses, or code names, or to database files 28 previously stored in the server 21. In addition, the index addresses 245 can be either URL addresses directly hyperlinked to other web sites or HTTPs directly hyperlinked to specific web pages.

After receiving the index keywords 141 from the client 11, the server 21 locates the index addresses 245 corresponding to the index keywords 141 and transmits the corresponding index addresses 245 and small icons 247 to the media playback program 12 to display the small icons 247 in the icon zone 123. Each of the small icons 247 corresponds to any of the index addresses 245 to be linked to the predetermined content files 26. Alternatively, each of the small icons 247 can be linked through a specific index address 245 to a URL address where a web site is located, or to an HTTP where a specific web page is located. In the meantime, the client 11 displays the content file 26, to which one of the index address 245 is linked, in the display zone 121, and then the user can click on the small icon 247 to enable the small icon 247 to be linked to the predetermined content file 26 through the corresponding index address 245 and to enable the content file 26 to be displayed in the display zone 123 or in a new opened window.

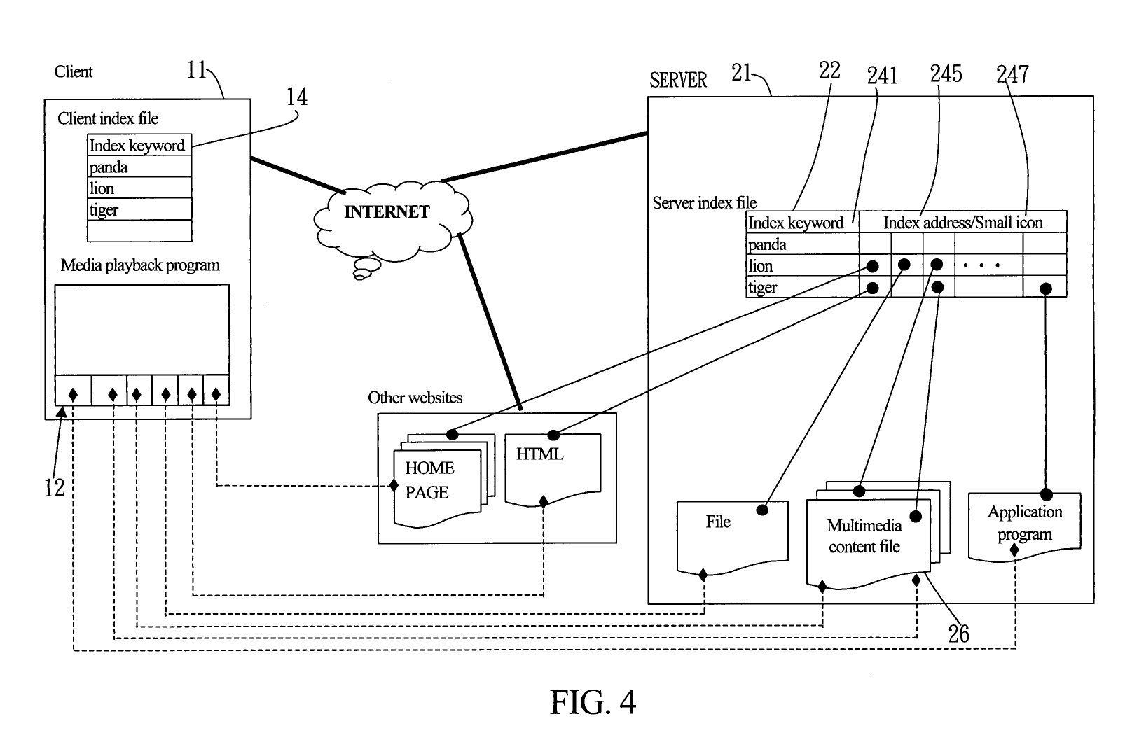

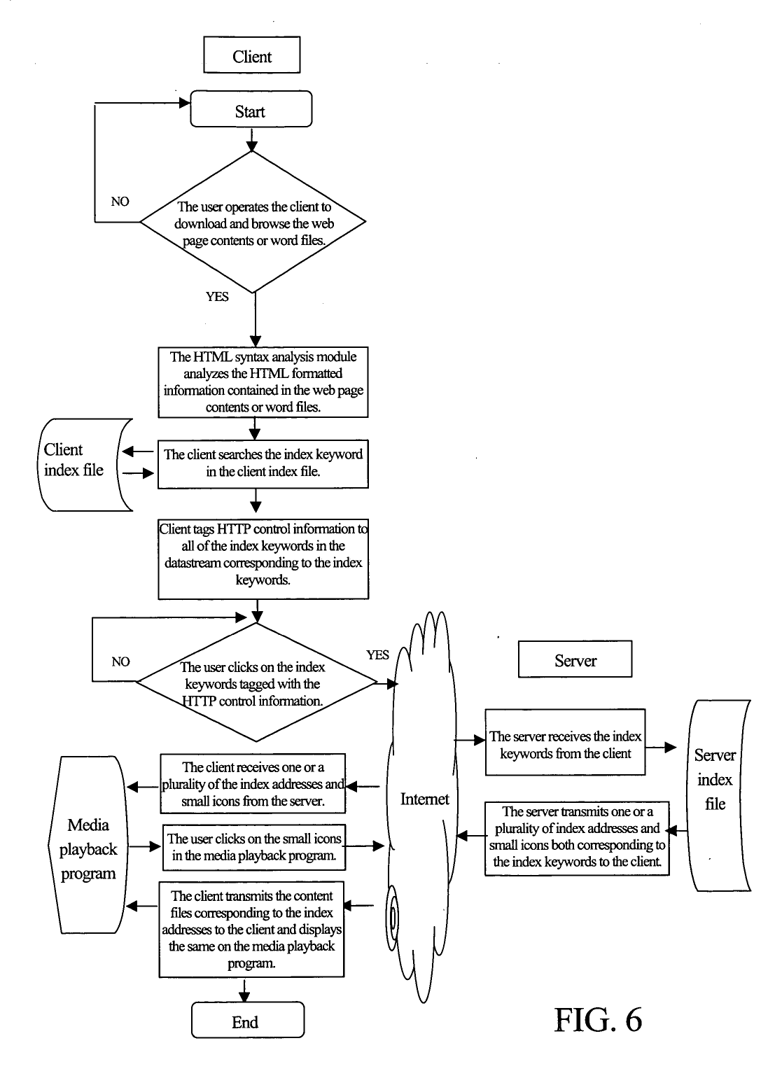

As indicated above, the present invention enables the user to do the content search with mouse-click. As shown in FIGS. 1-5, while browsing web pages or text files, the client 11 employs the HTML syntax analysis module 18 (FIG. 1) to analyze each of the index keywords 141 and tag the control information to the index keyword 141 and to further mark the words identical to the index keywords 141 on the web page with predetermined colors or distinctive markers (e.g. external frames) for display, or not to mark the words with additional colors but to display the original words, or to change the icon of the mouse cursor to prompt the index keywords, thus enabling the words of the content on the web page relevant to the index keywords 141 to be directly clicked with the input device 16. While browsing the web pages to be aware of desired index keywords 141, the user merely clicks on the index keyword 141 with the input device 16 and then the client 11 directly transmits the index keyword 141 to the server 21 because the index keyword 141 has been compared with the client index file 14 while tagged with the control information. After receiving the index keywords 141 from the client 11, the server 21 locates corresponding index addresses 245 and transmits the index addresses 245 and their corresponding small icons 247 to the media playback program 12 of the client 11 to display them in the icon zone 123. FIG. 6 shows a complete flow of the aforementioned index manner.

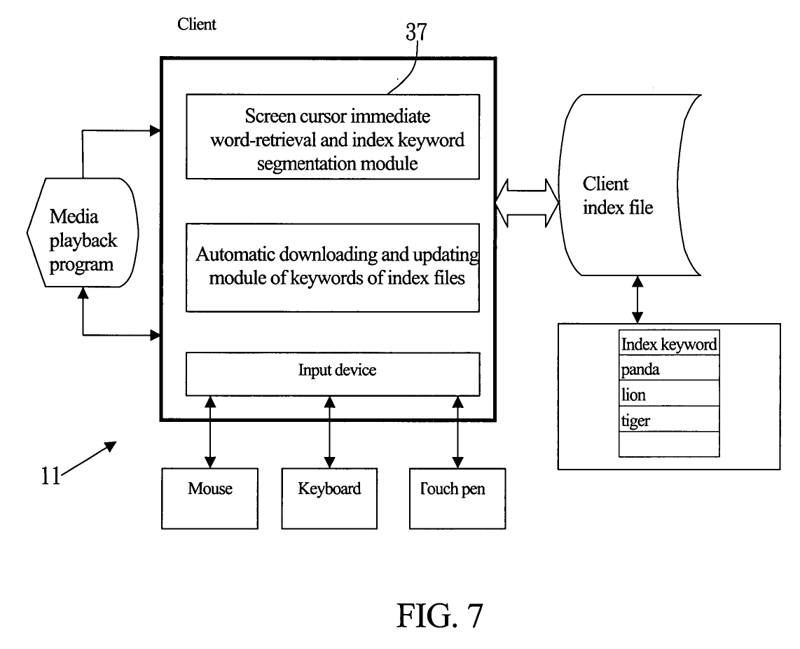

As shown in FIG. 7, the Internet-based search method of contents by means of relevant lexicons, in accordance with a second preferred embodiment of the present invention, is similar to the first embodiment, but having difference as recited below.

The client 11 further includes a screen cursor immediate word-retrieval and index keyword segmentation module 37 primarily for recognition of the words beside the screen cursor on the client 11. The user can move the cursor on the client 11 to a word. After the module 37 retrieves the word, the client 11 compares whether the word is the same as the index keyword 141 of the client index file 14 or not. If they are the same, the word will be transmitted to the server 21. Because the word is retrieved through the module 37, it is unnecessary to tag the control information for this embodiment as the HTML syntax analysis module 18 of the first embodiment does. Although the user's word-retrieval manner of the second embodiment is different a bit from that of the first embodiment, the follow-up comparison and search manner of the second embodiment is the same as that of the first embodiment to be unnecessarily discussed further.

In addition to the manner indicated in the second embodiment, there is still an alternative one enabling retrieval of the word that the user intends to search. In other words, the user can input desired words for search directly into the client 11 with a keyboard (an input device) and find desired content according to the search manner of the first embodiment after the comparison between the index keyword and client index file.

As indicated above, while the datastream of the web pages enters the client, the present invention analyzes the web pages to further generate hidden links for keywords on the web pages, as the above-mentioned control information tagged with the HTTP, and to insert the hidden links into the web pages to enable the user to click on the keyword desired for index with a manner similar to hyperlinks shown on web pages. The present invention also enables the user's immediate word-retrieval with the screen cursor immediate word-retrieval and index keyword segmentation module from the web pages or word files to function as an immediate index. Besides, the present invention enables the user to directly input words desired for search with the keyboard to effect simple and rapid word-retrieval actions for the web pages or contents of documents shown on the client, further locating the contents relevant to the index keywords.

What is claimed is:

1. An Internet-based search method of contents by means of relevant lexicons enabling search actions of contents relevant to lexicons between a client and a server, wherein said client comprising:
a media playback program having a display zone and an icon zone for displaying a predetermined content and showing a plurality of predetermined icons respectively;
a client index file having a plurality of index keywords; and
an input device for input of predetermined words desired for search;
while an search action is done, said input device is used for inputting desired words for search into said client, and then said client compares whether the desired words are the same as said index keywords or not; if the same, said index keywords will be transmitted to said server;
said server comprising a server index file, said server index file having a plurality of index keywords, at least one index address corresponding to each of said index keywords, and an icon corresponding to each of said index addresses, each of said index addresses being linked to a predetermined content file;
whereby said server locates a corresponding index address after receiving said index keyword from said client, and then transmits said located index address and its corresponding small icon to said media playback program to display said small icon in said icon zone, each of said small icons corresponding to each of said index addresses to be linked to predetermined content file, said client displaying the content file linked to one of said index addresses in said display zone of said media playback program; while operating said method, a user can click on said small icons to be linked to said predetermined content files through said index addresses to enable said content files to be displayed on said display zone or in a new opened window.

2. The search method as defined in claim 1, wherein said icon zone of said media playback program is located beneath said display zone.

3. The search method as defined in claim 1, wherein said input device is a mouse, a keyboard, or a touch pen.

4. The search method as defined in claim 1, wherein said predetermined content files are any of words, videos, audios, images, graphs, animations, file names, database content, web pages, hyperlinks of web pages, uniform remote locator (URL) addresses, and code names.

5. The search method as defined in claim 1, wherein said client further comprises an automatic downloading and updating module of keywords of index files for automatically updating said keywords of said index files of said client to be the same as those of said server at any time while said client is connected with said server, whereby said client keeps its data synchronized with those of said server.

6. The search method as defined in claim 1, wherein said client is a personal computer, a notebook computer, a cellular phone, or a personal digital assistant.

7. The search method as defined in claim 1, wherein said client further comprises at least one hypertext markup language (HTML) syntax analysis module for recognition of HTML formatted information contained in predetermined contents of datastream received by said client, said HTML syntax analysis module comparing index keywords of said client index files to locate all of said index keywords of said datastream and to tag hypertext transfer protocol (HTTP) control information to all of said index keywords of said datastream to enable words relevant to said index keywords of said predetermined contents for the user's direct click with said input device.

8. The search method as defined in claim 7, wherein said datastream received by said client is either transmitted from said server or received from web pages or files opened by the user's self.

9. The search method as defined in claim 7, wherein said index keywords tagged with said HTTP control information are shown on web pages with predetermined colors or distinctive markers.
